(19) United States
(12) Patent Application Publication
(10) Pub. No.: US 2004/0093287 A1
(43) Pub. Date: May 13, 2004

(54) Method for optimal demanufacturing planning

(76) Inventors: Barun Gupta, Shelton, CT (US); Sarah E. Santo, Poughkeepsie, NY (US)

Correspondence Address: FREDERICK W. GIBB, III, MCGINN & GIBB, PLLC, 2568-A RIVA ROAD, SUITE 304, ANNAPOLIS, MD, 21401, US

(21) Appl. No.: 10/290,687

(22) Filed: Nov. 8, 2002

(51) Int. Cl. G06F 17/60

(52) U.S. Cl. 705/29

(57) ABSTRACT

A method and apparatus that maintains a database of the demands over time for all the different refurbished machines is disclosed. The invention also maintains the supply over time of all the different machines that will be returned from expired leases. The invention maintains the relationship for alternate parts which parts can be used in place of another. The invention also maintains an inventory of parts and machines. As machines are returned from expired leases, they come into inventory. From this inventory, some of the machines will, from time to time be scheduled to be refurbished or demanufactured. The balance will remain in inventory. When a machine is demanufactured, all of the parts that are produced will be put in inventory. However, some may be used immediately to satisfy a demand for the part and the balance may be used to satisfy demand for the same part later or be used as an alternate part for some other part. The invention also maintains a bill-of-materials that is a cross reference of all the parts that can be produced from each machine. Related to this are parametric data that is required. These data are yields associated with the refurbishing and demanufacturing process, the offset or time required for these processes, the resources required and the capacity of the resource, etc. The final set of information that is maintained by the invention are the priorities of the different demands. These priorities can be time sensitive, if required. These priorities reflect the economic advantage of satisfying one demand before another. For example, demands for refurbished machines may have a high priority, reflecting the consideration that refurbishing generally requires minimal effort and generates a large revenue and profit. Demands (auction/sales) for certain parts sometimes have a high resale value and they would be given a high priority. Finally, most of the other demands (service, sales and auctions) for parts may have a lower priority.

### CROSS-REFERENCE TO RELATED APPLICATION

The present application is related to U.S. patent application Ser. No. 09/808,067, which is assigned to the same assignee, and is incorporated herein by reference.

### BACKGROUND OF THE INVENTION

1. Field of the Invention

The present invention generally relates to maximizing the demands for parts and machines that can be satisfied by refurbishing machines and demanufacturing (disassembling) the machines to produce the parts. More particularly, this invention relates to a system and method that determines an optimal schedule of refurbishing and demanufacturing these devices.

2. Description of the Related Art

Recycling of obsolete and unwanted products provides benefits over alternatives such as disposal in landfills or incineration. Such recycling benefits individuals, companies, and society both financially and by reducing the impact of disposal on the environment. Although applicable to most manufactured products, recycling is of particular interest for information technology products such as personal computers, displays, printers, and associated devices because of the ever-shortening life-cycle before obsolescence of such products.

Finance companies often arrange financing for customers to lease computers. These include computers that are made by many different manufacturers. These leases are generally for a fixed duration, after which, the leasing company (or a given manufacturer) is left with a large number of used, and potentially obsolete computers. This equipment may be resold, if there is demand, to consumers with a minimal amount of testing and refurbishing. Alternatively, these devices can be wholly or partially disassembled to remove any parts which may have resale value. The remaining product is then typically separated into basic materials such as plastics, precious-metals, copper, steel, glass, etc., to be sold for their commodity values. If the returned leased computers are demanufactured, this produces a large number of parts, some of which may be related, and some may not. These parts are valuable and can be used to satisfy service demands (replacement of defective parts in the field), or sold as used parts (sometimes in the form of auctions).

There is a demand for refurbished machines, for parts to be used for service, and for parts to be sold/auctioned. There also is a predictable supply (over time) of leased machines that will be returned. There are many thousands of different machines that can be returned every month. Adding to this complexity is that the same part can be produced by demanufacturing many different machines. Adding even more complexity is that there could be several similar parts that can be substituted for each other. The demanufacturing and refurbishing processes consume resources which cost money. Therefore, one problem to be solved is the best way to determine an optimal refurbishing and demanufacturing schedule of the supply of returned machines that best satisfies the demand for refurbished machines, used parts and service parts. This demanufacturing and refurbishing schedule only processes the machines that need to be demanufactured or refurbished in order to satisfy a demand for a refurbished machine or part that cannot be satisfied from inventory of that part or an alternate part. This invention provides an integrated solution to this problem.

### SUMMARY OF THE INVENTION

In view of the foregoing and other problems, disadvantages, and drawbacks of the present systems that handle returned used computer equipment, the present invention has been devised, and it is an object of the present invention to provide a structure and method for improving the handling of used computer equipment.

This invention maintains a database of the demands over time for all the different refurbished machines, the demands for parts that can be sold (including auctions) and the demands for parts that will be required to support service requirements. The invention also maintains the supply over time of all the different machines that will be returned from expired leases. The invention maintains the relationship for alternate parts which parts can be used in place of another. The invention also maintains an inventory of parts and machines. As machines are returned from expired leases, they come into inventory. From this inventory, some of the machines will, from time to time be scheduled to be refurbished or demanufactured. The balance will remain in inventory. When a machine is demanufactured, all of the parts that are produced will be put in inventory. However, some may be used immediately to satisfy a demand for the part and the balance may be used to satisfy demand for the same part later or be used as an alternate part for some other part. The invention also maintains a bill-of-materials that is a cross reference of all the parts that can be produced from each machine. Related to this are parametric data that is required. These data are yields associated with the refurbishing and demanufacturing process, the offset or time required for these processes, the resources required and the capacity of the resource, etc. The final set of information that is maintained by the invention are the priorities of the different demands. These priorities can be time sensitive, if required. These priorities reflect the economic advantage of satisfying one demand before another. For example, demands for refurbished machines may have a high priority, reflecting the consideration that refurbishing generally requires minimal effort and generates a large revenue and profit. Demands (auction/sales) for certain parts sometimes have a high resale value and they would be given a high priority. Finally, most of the other demands (service, sales and auctions) for parts may have a lower priority.

The invention starts with the highest priority demand and determines the best way to satisfy it. It takes into consideration, the available inventory of the part/machine, available inventory of an alternate part/machine, current supply of machines that can be refurbished, demand for refurbished machines, and current supply of machines that can be demanufactured.

This data is brought into any one of several different APS (Advanced Planning Tools) that has the capability of modeling co-products as well as alternate parts. This invention is not specific to the tool used and the concept can be applied individually to each tool. The reverse BOM (bill-of-materials) is modeled as co-products with the co-products that are produced modeled as alternates as applicable. Generally, one is considered a prime and the others are alternates for it.

### BRIEF DESCRIPTION OF THE DRAWINGS

The foregoing and other objects, aspects and advantages will be better understood from the following detailed description of a preferred embodiment(s) of the invention with reference to the drawings, in which:

FIG. 1 is a schematic diagram of that illustrates supply, products, parts and demand;

FIG. 2 is a flowchart illustrating one embodiment of the invention;

FIGS. 3a-3c are charts showing examples of the invention;

FIG. 4 is a hardware diagram for use with the invention;

FIG. 5 is a flow diagram illustrating one embodiment of the invention; and

FIG. 6 is a flow diagram illustrating one embodiment of the invention.

### DETAILED DESCRIPTION OF PREFERRED EMBODIMENTS OF THE INVENTION

The invention maintains databases of components in inventory that are the result of the disassembly of products (machines) in the past and where all the parts were not used, inventory of products (machines) that were previously refurbished and not sold (or otherwise disposed off), inventory of products (machines) that came off a lease and were returned and have not been refurbished or disassembled.

The databases also include demand data. The invention assumes that there is some other demand planning process in place to forecast different demand streams. Each demand stream is a forecast of the demand for a particular refurbished product or reconditioned part to be sold in different ways. For example, there could be demand streams where each demand stream was the forecast for a particular product to be sold to a particular customer. There could be different customers, different sales regions, different channels, etc. The same concept of a demand stream applies to reconditioned parts as well. Reconditioned parts are parts that come from dismantling a product and (if necessary) cleaning it, subjecting it to testing as appropriate, etc. This demand planning process could be based on historical data and using statistical methods like moving averages, regression techniques, exponentially smoothed forecasting techniques etc. In addition to the demand streams based on products (machines) and reconditioned parts, the database also includes priorities for each demand stream.

Priorities of the demand statements are relative to each other and essentially represent the sequence in which a certain demand stream is to be satisfied. A separate process determines what these demand statement priorities are. That process could be based on the cash flow or profit generated by selling a particular product or reconditioned part. In fact, by being able to deal with demand streams, the invention allows for different demand priorities to be set for a particular product or reconditioned part in different ways. For example, selling a product in bulk lots to resellers might have a per unit revenue or profit that is lower than what could be realized by selling individual products over the internet. The priority of the demand stream for bulk lots to resellers could then be set lower than the priority of the demand stream over the internet. The same applies to reconditioned parts.

In addition, there may be situations where there is a business reason to have a preference of demanufacturing a product to produce a reconditioned part that can be sold in a particular way over refurbishing the product and selling the refurbished part. In this situation, the demand stream based on the refurbished product would have a lower priority than the priority of the demand stream based on the reconditioned part. One such example would be when a company is obligated to provide spare parts to support its products in the field and there is a preference for using reconditioned (that is parts recycled from machines) parts. In this situation, even though there may be some revenue and profit associated with selling a refurbished machine, that profit is outweighed by the need to satisfy its service requirement. These priorities can even be time sensitive. That is, the relative priorities for the demand streams based on products and reconditioned parts may change over time.

Also included in the databases are supply data. Companies continuously lease products (machines). These leases are for a fixed duration and at the end of the lease, the machine is returned. Therefore, at any point in time, the number of machines that will be returned and the timing of their return can be determined. This has to be adjusted to take into account the fact that some leasees may choose to buy out the lease. In other words, the customer may choose to pay a sum of money and keep the product (machine) that was leased and not return it. These adjustments, if they apply, serve to reduce the supply of machines (products) coming off leases and can be estimated.

The next set of data that is maintained in the database includes the bill-of-materials, refurbishing parameters, demanufacturing parameters etc. The bill-of-materials is a cross reference between the product and the components included in the product. This provides a listing of parts that would result from disassembly. The refurbishing parameters would include the time it takes to refurbish a machine, capacity in terms of the resources (people or equipment), yields, etc. In other words, the refurbishing operations use resources. These resources include people and equipment. If either or both types of resources are gating factors because of skills, labor shortages, limited equipment, etc., then the invention can be adapted to take these into account as well. In this case, the invention would determine an optimal demanufacturing/refurbishing schedule that is also feasible within the resource (people and equipment) constraints. The yield factor allows for the fact that refurbishing will not be successful at every machine. Some percentage of refurbishing would fail for a variety of reasons. The internal product could have deteriorated to the point that it cannot be refurbished, or the machines (products) itself could have been returned in a damaged condition. Also, the refurbished machines could fail the testing process, etc. The invention allows for a yield factor to be applied that takes these into account. The demanufacturing parameters are very similar to the refurbishing parameters.

All of this data is collected periodically and maintained in the database and could be collected (for example) weekly or monthly. The invention allows for data to be collected at whatever frequency is deemed best: daily, weekly, bi-weekly, monthly, etc. At whatever frequency is deemed appropriate, this data is brought into an APS (Advanced Planning and Scheduling) tool. There are many such APS tools in the marketplace and this invention applies to any of them. The APS tool should have the capability to model co-products and alternate parts. The concepts in this invention are the same and the implementation solution would be slightly different depending on the specific tool being used. When this data is brought into an APS tool, the tool is run. The demanufacturing operation is represented as an operation that produces co-products. In addition, where one part can be used in place of another, this is modeled as alternate parts.

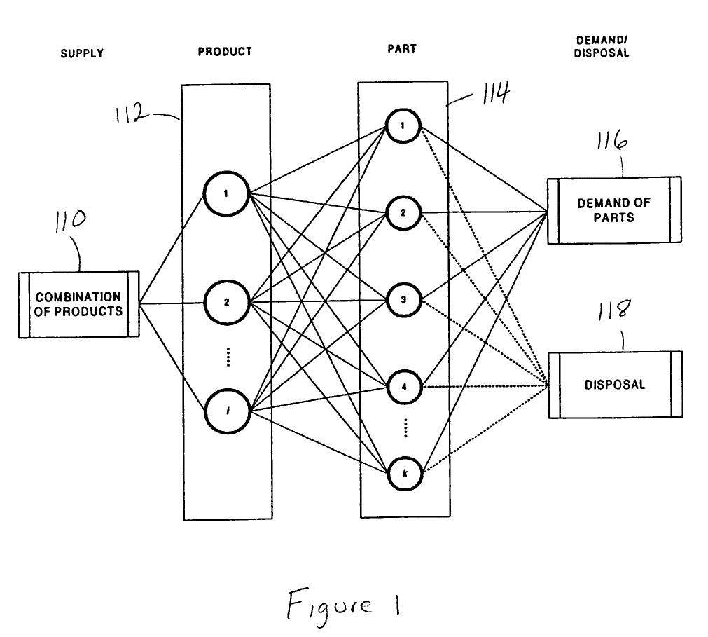

Referring now to FIG. 1, a conceptual representation of items produced by the demanufacturing process is shown. More specifically, item 110 shows a grouping of products that can be broken down into different individual products, as shown in item 112. Each of the different products shown in item 112 is made up of constituent parts, as shown in item 114. Many of these components are shared by different products. For example, all the products in item 112 share the first component part shown in item 114. However, it is not expected that all products will have the exact same component makeup. Item 116 represents the demand for the various component parts and item 118 represents disposal of the constituent parts through either a destructive recycling (for material recovery) or simply a non-productive disposal into a garbage system, such as a landfill.

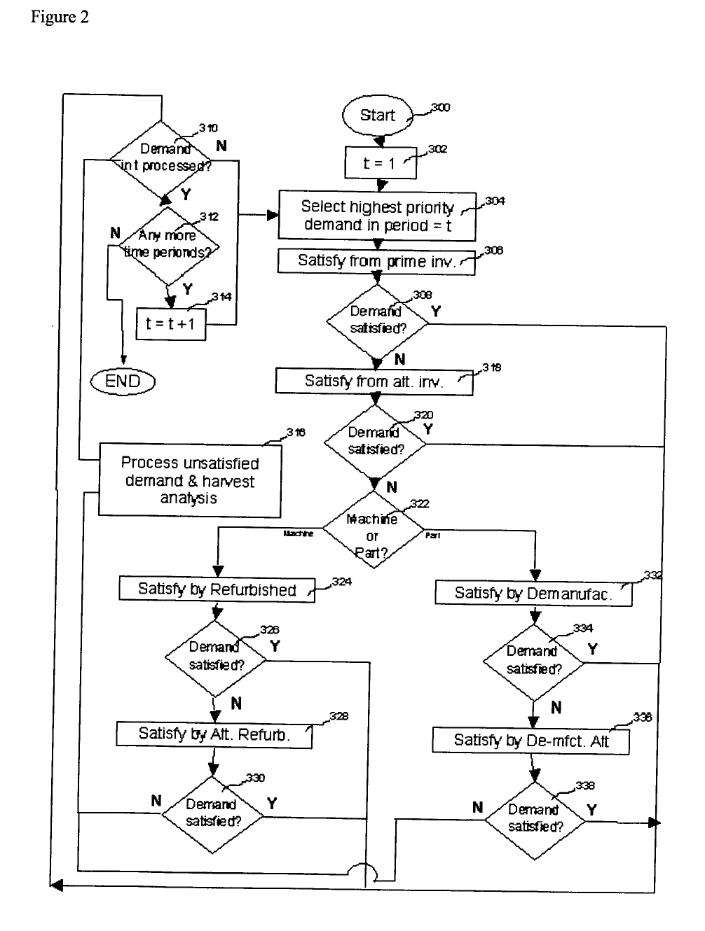

FIG. 2 represents the conceptual flow used. The flow starts by selecting the demand stream with the highest priority in the first time period. This is represented by 300, 302 and 304. Starting with the highest priority demand, the tool will compare the demand for that demand stream to the available inventory of that product or reconditioned part that the demand stream is based on. This is represented by 306. The difference between the demand and the portion of the demand that is covered by refurbished product or reconditioned parts in inventory is a net requirement that still needs to be satisfied. This is represented by 308. If the product or reconditioned part has an alternate, then the inventory of the alternate will be checked to see if the net requirement can be satisfied. This is represented by 318. After using up the alternate inventory, if there is still a portion of the demand stream that is unsatisfied (step 320), then the invention will now plan for a machine to be refurbished or a machine to be demanufactured to produce a reconditioned part that will be used to satisfy the remaining demand. Step 322 determines if the demand stream that is being processed is based on a machine or a reconditioned part.

Consider an example. If the demand stream for a refurbished machine to be sold via a particular channel was 100 in week 5 and the available inventory was 6, then the net requirement of 94 may be satisfied by an alternate machine. If there was no inventory of the alternate machine, then this remaining net requirement of 94 will have to be satisfied by scheduling machines to be refurbished. If the lead time (one of the refurbishing parameters) is 1 week, then the machines would have to be scheduled for week 4 (so that they are available in week 5). Also, if the yield is 90%, then 105 machines would have to be scheduled for refurbishing in week 4. This was arrived at based on 94/0.9=104.4, rounded up to 105. So by starting 105 machines in week 4, 94 machines could be expected to be available in week 5 and that, in addition to the 6 refurbished machines available in inventory would be used to satisfy the demand for 100 refurbished machines in week 5. All of this is represented by step 324 and assumes that 105 un-refurbished machines were available in inventory or that there were enough un-refurbished machines coming in (along with what is in inventory) to have 105 machines available in week 4. If that were not the case, then the APS tool would consider the alternates that could be used. This is represented by step 326 and 328. That is, if there were other machines that were considered as alternates, then the APS tool would consider the supply (inventory or machines coming back from a lease and available to be refurbished). If there were still not enough machines available, then depending on the parameters being used, the tool would consider satisfying that left over demand in week 5, in a later week, say week 6 first then week 7 etc. This is because there may be a supply of machines available in a future time period.

With reconditioned parts this is a little different. First, the tool would consider satisfying the demand stream based on part A from what is available in inventory. This is represented by step 306. The demand stream based on part A may be 150 in week 3 and the inventory may be 27. That leaves a net requirement of 123. The tool would consider satisfying this net requirement of 123 with an alternate reconditioned part that may be in inventory. This is step 318. For this example, assume that there are no alternate reconditioned parts. The net requirement of 123 of this part, part A, can be produced by demanufacturing several different machines. The cross reference of part to machine is in the bill-of-material data. Generally, one machine would be considered as the prime source and the others as alternates. The tool would first determine if 145 (123 adjusted for a yield of 85%) could be scheduled for demanufacturing in week 1 (assume a 2 week demanufacturing lead time). This is represented by step 332. If there were not enough of the prime machines, the tool would then consider each alternate in turn. This is represented by step 336. Finally, after exhausting the alternates, the tool would then consider satisfying the net requirement of 145 (net requirement of 123 adjusted for a yield of 85%) in week 3 in a later period, which would mean scheduling machines for demanufacturing in a week later than week 1, with the demand being met late.

It should also be pointed out that the inventory of parts at any point in time is the physical inventory plus inventory added as a result of demanufacturing a machine, less what has been consumed to satisfy a demand. In other words, the tool may have processed another demand stream based on a part (say part B) before this one. While processing part B, it may have required a machine to be demanufactured to produce part B. When that machine is demanufactured to produce part B, part A may be a part that is also produced (this is modeled as a co-product). The tool adds this supply of part A to the physical inventory of part A. As this running total of inventory is consumed, the tool automatically reduces the running total of inventory available by the amount that is consumed.

The tool generally processes each demand stream sequentially. When a demand stream has been processed (step 330 for a product or 338 for a part) either the entire demand stream has been satisfied or there is a portion that cannot be satisfied. If there is some portion of the demand stream that cannot be satisfied, this information is collected (step 316). As processing continues, the next step is to determine if there are any remaining demand streams in this time period that have not been processed (step 310). If there are remaining demand streams, then the tool will select the next demand streams to be processed. This selection is based on the highest priority of the remaining demand streams (step 304). If all the demand streams in this time period have been processed, the next step is to determine if there are any additional time periods (step 312). If there are more time periods, then the tool will move to the next time period (step 314) and in this new time period it will select the demand stream with the highest priority (step 304) and process the demand stream as before. If there are no more time periods left to be processed, the program will end.

While doing all this, these APS tools generally collect and store all the data in a database that is then used to generate reports. Some common reports are:

A) Refurbishing plan: Which machines should be refurbished and when.

B) Demanufacturing plan: Which machines should be demanufactured and when.

C) Supply Commit plan: Shows all the demand streams and the extent to which each can be covered.

D) Inventory report: shows the projected inventory of all items in units and dollarized.

After all the demand streams have been processed, all the unsatisfied demand streams are candidates for the harvest analysis. The “harvest” analysis basically determines whether it is economically a good idea to break a lease and ask for some leased products to be returned early. Factors that are considered are the penalties that have to be paid to break a lease, the loss of lease revenue/profit from the old lease, and that is balanced against the profit/revenue from satisfying the remaining unsatisfied demand stream.

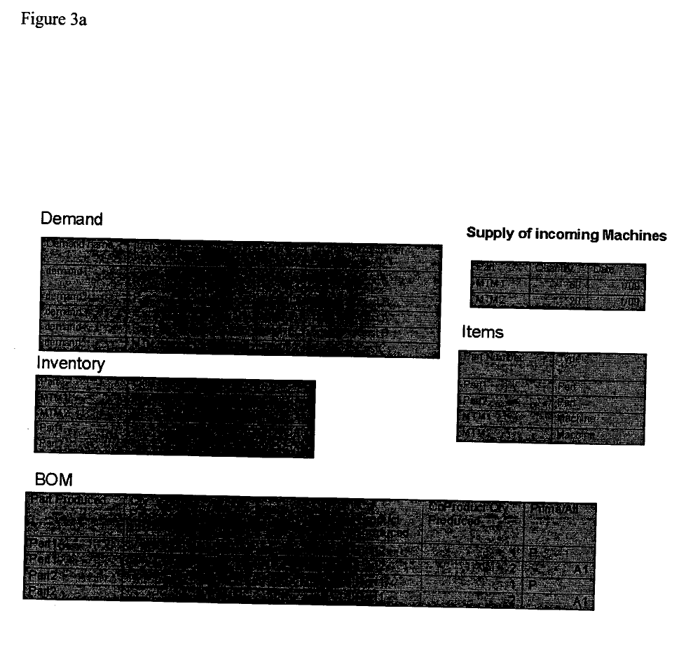

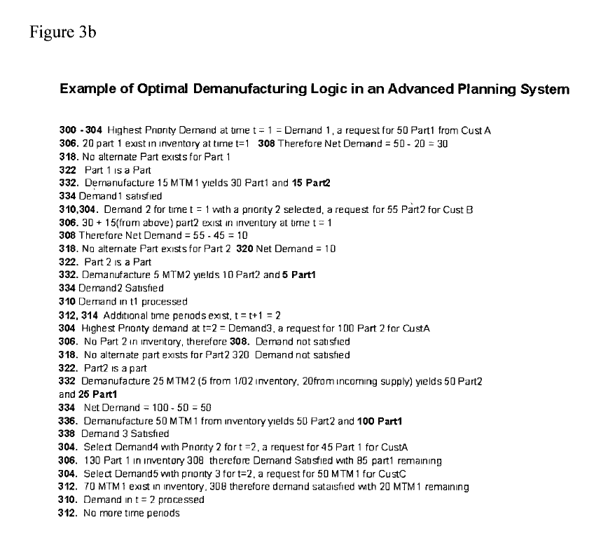

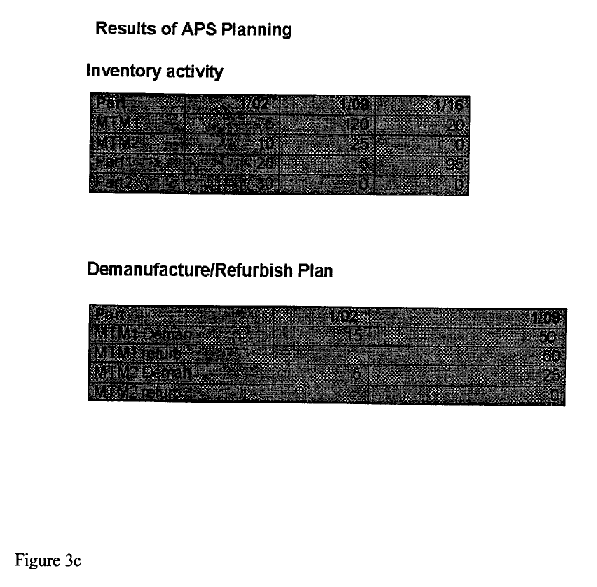

FIG. 3a illustrates a number of items as they may appear in the inventive database. For example, FIG. 3a illustrates demand statements that include the demand name, the item requested in the demand statement, the quantity requested, the date the item is needed, the priority of the demand statement, as well as which customer is requesting the item. FIG. 3a also illustrates the supply of incoming machines which include a part identification, quantity, and the date that the machine will be returned. Item 3a illustrates an inventory database portion that includes a part identification, quantity, and the date that the quantity will be in inventory. FIG. 3a also illustrates and “Items” portion of the database which identifies whether an item is a part or machine depending upon part number. Also shown in FIG. 3a is the bill-of-materials that includes an identification of the parts produced, the quantity produced, the part consumed, the quantity consumed, co-products produced, the quantity of co-products that are produced, as well as an identification of whether the part is a prime part or an alternate part.

FIG. 3b shows a self-explanatory example of an optimal demanded factoring analysis and includes references to the items shown in FIG. 2. FIG. 3c illustrates some results of APS planning with the invention. For example, FIG. 3c shows the inventory activity of various parts at various dates. In addition, FIG. 3c shows the demanufacturer/refurbish plan for various parts at various dates.

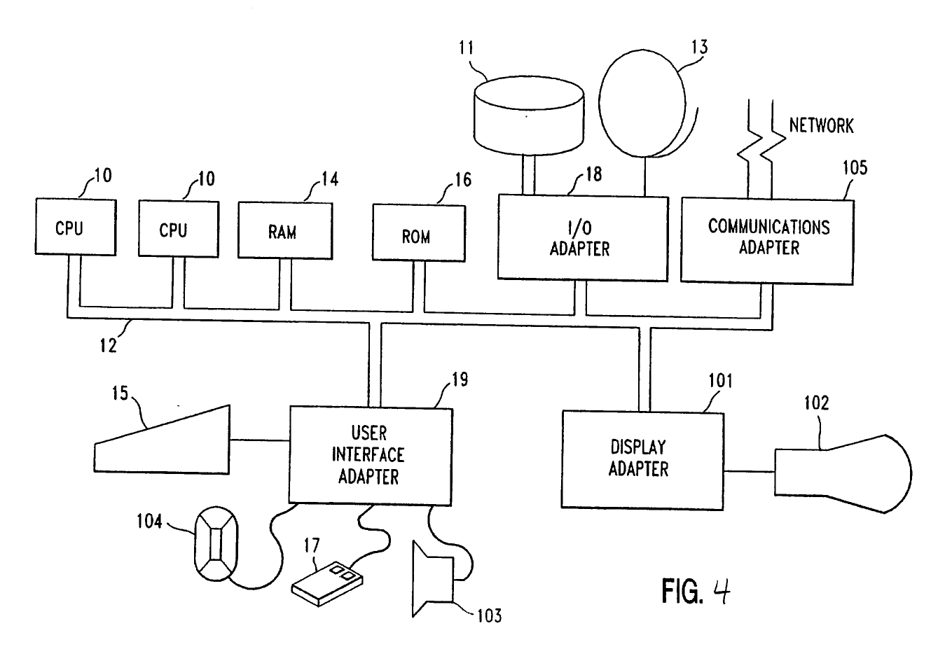

A representative hardware environment for practicing the present invention is depicted in FIG. 4, which illustrates a typical hardware configuration of an information handling/computer system in accordance with the subject invention, having at least one processor or central processing unit (CPU) 10. CPUs 10 are interconnected via system bus 12 to random access memory (RAM) 14, read-only memory (ROM) 16, an input/output (I/O) adapter 18 for connecting peripheral devices, such as disk units 11 and tape drives 13, to bus 12, user interface adapter 19 for connecting keyboard 15, mouse 17, speaker 103, microphone 104, and/or other user interface devices such as touch screen device (not shown) to bus 12, communication adapter 105 for connecting the information handling system to a data processing network, and display adapter 101 for connecting bus 12 to display device 102. A program storage device readable by the disk or tape units, is used to load the instructions which operate on a wiring interconnect design which is loaded also loaded onto the computer system.

Another aspect of the invention revolves around selecting the best machine to disassemble, to maximize the volume of parts that are needed, and to minimize any surplus of unneeded components. Initially, the invention consumes available inventory before recommending disassembly of any products. Once available inventory will be exhausted, the invention plans disassembly of various products. In order to maximize the volume of parts produced from the disassembly, the invention calculates the volume of components that will be produced by the disassembly procedure including the disassembly of components into sub-components. This procedure is known as attribute aliases-based planning.

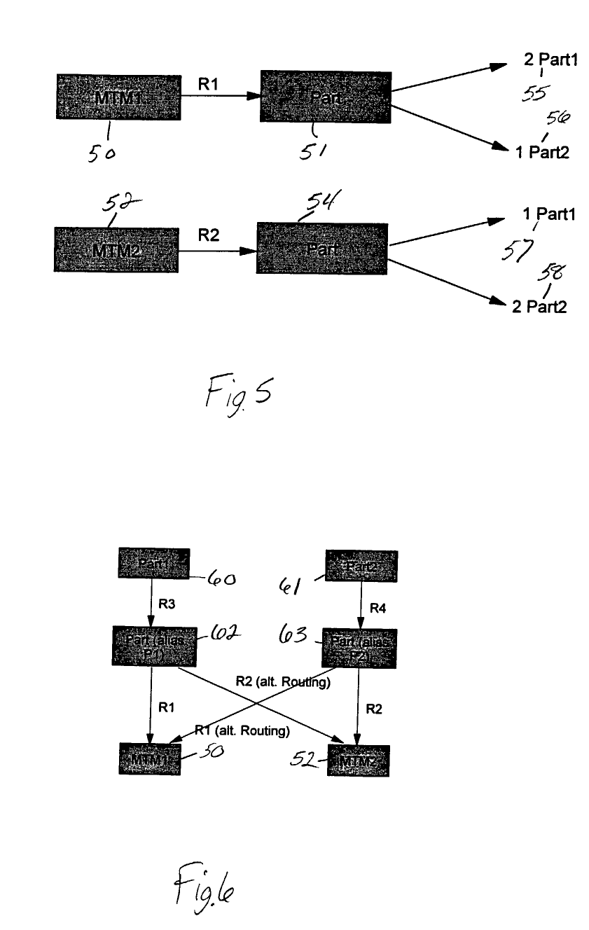

For example, FIG. 5 illustrates two machine type models 50, 51 (MTM1, MTM2) each of which produces a part 51, 54. The different parts 51, 54 can each be divided into the same sub-component parts (55-58). However, part 51 contains one Part2 (56) and two Part1s (55). To the contrary, part 54 contains one Part1 (57) and two Part2s (58). Therefore, if there was a need for Part2, and little or no need for Part1, all of the parts 54 (and machines 52) should be disassembled before any of the parts 51 are disassembled in order to maximize the number of Part2s that are produced and to minimize the number of unneeded Part1s that are produced.

In other words, once the invention determines that machines should be disassembled to produce component parts, the invention ranks the order in which the machines should be disassembled in order to maximize the number of needed parts that are produced and to minimize the number of unnecessary (and unwanted) surplus component parts that are produced.

In addition, the invention provides the ability to address alternate parts at a level other than the procured level. More specifically, as shown FIG. 6, the demand for a specific sub-component 60 can be correlated with an aliasing part 62 that is produced by either machine 50, 52. Part 61 and aliasing part 63 can similarly be produced by either machine 50, 52. As shown above, machine 50 or machine 52 may produce different quantities of the different parts 60, 61.

As shown above, the invention prioritizes the demand statements, thereby improving the performance of conventional APS systems. With the invention, demand statements having a higher priority will be processed before lower-priority demand statements. This allows planning tools to be more sensitive to different corporate objectives such as satisfying a particular customer or performing activities that have been identified by corporate management having a higher importance to the organization.

While the invention has been described in terms of preferred embodiments, those skilled in the art will recognize that the invention can be practiced with modification within the spirit and scope of the appended claims.

What is claimed is:

1. A method of optimally demanufacturing products containing components and refurbishing said products based on demand statements for said components and said products, said method comprising:
receiving at least two of said demand statements, each of said demand statements comprising an identifier, a quantity, and a demand statement priority;
satisfying said demand statements based on demand statement priorities; and
at least one of:
identifying at least one product to be demanufactured in order to satisfy said demand statements; and
identifying at least one product to be refurbished in order to satisfy said demand statements.

2. The method recited in claim 1, further comprising accessing at least one bill-of-materials for each of said products, wherein said bill-of-materials lists components contained in each of said products, wherein said identifying of said product to be demanufactured is based on a bill-of-materials for said product.

3. The method recited in claim 1, wherein said demand statement further comprises a time period; and
wherein said satisfying of said demand statements is further based on said time period.

4. The method recited in claim 1, further comprising receiving at least one supply statement comprising a supply identifier and a supply quantity.

5. The method recited in claim 1, wherein said satisfying of said demand statements further comprises mapping said identifier to a substitute.

6. The method recited in claim 1, wherein said demand statement priority is based on at least one of economic benefit and service requirements.

7. The method recited in claim 1, wherein said satisfying of said demand statements further comprises satisfying said demand statements from inventory before demanufacturing said products.

8. The method as recited in claim 1, wherein said satisfying of said demand statements further comprises harvesting said products.

9. A method of optimally demanufacturing products containing components based on demand statements for said components, said method comprising:
receiving at least two of said demand statements, each of said demand statements comprising a component identifier, a quantity, and a demand statement priority;
satisfying said demand statements based on demand statement priorities; and
identifying at least one product to be demanufactured in order to satisfy said demand statements.

10. The method recited in claim 9, further comprising accessing at least one bill-of-materials for each of said products, wherein said bill-of-materials lists components contained in each of said products, wherein said identifying of said product bill-of-materials for said product.

11. The method recited in claim 9, wherein said demand statement further comprises a time period; and
wherein said satisfying of said demand statements is further based on said time period.

12. The method recited in claim 9, further comprising receiving at least one supply statement comprising a supply identifier and a supply quantity.

13. The method recited in claim 9, wherein said satisfying of said demand statements further comprises mapping said component identifier to a substitute component.

14. The method recited in claim 9, wherein said demand statement priority is based on at least one of economic benefit and service requirements.

15. The method recited in claim 9, wherein said satisfying of said demand statements further comprises satisfying said demand statements from inventory before demanufacturing said products.

16. The method as recited in claim 9, wherein said satisfying of said demand statements further comprises harvesting said products.

17. A method of optimally demanufacturing products containing components and refurbishing said products based on demand statements for said components and said products, said method comprising:
receiving at least two of said demand statements, each of said demand statements comprising an identifier, a quantity, and a demand statement priority;
maintaining a database of said components available in products awaiting recycling;
maintaining a database of an inventory supply of said components;
satisfying said demand statements based on demand statement priorities; and
at least one of:
identifying products to be demanufactured in order to satisfy demand statements for said products; and
identifying products to be refurbished in order to satisfy demand statements for said components,
wherein said identifying of said products to be demanufactured comprises:
comparing demand statements for said components with said inventory supply of said components to identify needed components;
matching said needed components to said components available in said products awaiting recycling to identify products to be disassembled; and
ranking said products to be disassembled according to which product produces a greater number of needed components.

18. The method recited in claim 17, further comprising accessing at least one bill-of-materials for each of said products, wherein said bill-of-materials lists components contained in each of said products, wherein said identifying of said product to be demanufactured is based on a bill-of-materials for said product.

19. The method recited in claim 17, wherein said demand statement further comprises a time period; and
wherein said satisfying of said demand statements is further based on said time period.

20. The method recited in claim 17, further comprising receiving at least one supply statement comprising a supply identifier and a supply quantity.

21. The method recited in claim 17, wherein said scarifying of said demand statements further comprises mapping said identifier to a substitute.

22. The method recited in claim 17, wherein said demand statement priority is based on at least one of economic benefit and service requirements.

23. The method recited in claim 17, wherein said satisfying of said demand statements further comprises satisfying said demand statements from inventory before demanufacturing said products.

24. The method as recited in claim 17, wherein said satisfying of said demand statements further comprises harvesting said products.

25. A program storage device readable by machine tangibly embodying a program of instructions executable by said machine for performing a method of optimally demanufacturing products containing components and refurbishing said products based on demand statements for said components and said products, said method comprising:
receiving at least two of said demand statements, each of said demand statements comprising an identifier, a quantity, and a demand statement priority;
satisfying said demand statements based on demand statement priorities; and
at least one of:
identifying at least one product to be demanufactured in order to satisfy said demand statements; and
identifying at least one product to be refurbished in order to satisfy said demand statements.

26. The program storage device recited in claim 25, wherein said method further comprises accessing at least one bill-of-materials for each of said products, wherein said bill-of-materials lists components contained in each of said products, wherein said identifying of said product to be demanufactured is based on a bill-of-materials for said product.

27. The program storage device recited in claim 25, wherein said demand statement further comprises a time period; and
wherein said satisfying of said demand statements is further based on said time period.

28. The program storage device recited in claim 25, wherein said method further comprises receiving at least one supply statement comprising a supply identifier and a supply quantity.

29. The program storage device recited in claim 25, wherein said satisfying of said demand statements further comprises mapping said identifier to a substitute.

30. The program storage device recited in claim 25, wherein said demand statement priority is based on at least one of economic benefit and service requirements.

31. The program storage device recited in claim 25, wherein said satisfying of said demand statements further comprises satisfying said demand statements from inventory before demanufacturing said products.

32. The program storage device as recited in claim 25, wherein said satisfying of said demand statements further comprises harvesting said products.
